(19) United States
(12) Patent Application Publication
(10) Pub. No.: US 2026/0064600 A1
(43) Pub. Date: Mar. 5, 2026

(54) ATOMIC UPDATING OF PAGE TABLE ENTRY STATUS BITS

(71) Applicant: Akeana, Inc., Santa Clara, CA (US)

(72) Inventors: Ricardo Ramirez, Sunnyvale, CA (US); Sundeep Chadha, Austin, TX (US); Hai Ngoc Nguyen, Redwood City, CA (US); Abbas Rashid, Pleasanton, CA (US)

(73) Assignee: Akeana, Inc., Santa Clara, CA (US)

(21) Appl. No.: 19/313,912

(22) Filed: Aug. 29, 2025

Related U.S. Application Data
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.

(51) Int. Cl. G06F 12/1009; G06F 9/30

(52) U.S. Cl. CPC G06F 12/1009; G06F 9/30043; G06F 2212/654

(57) ABSTRACT

A processor core is accessed. The processor core supports virtual memory addressing. The processor core includes a memory management unit (MMU) and a load store unit (LSU). A page table walk is performed by the MMU. The page table walk is responsive to a memory operation. The page table walk identifies a page table entry (PTE) for a virtual to physical address translation. The PTE is read. The reading obtains a first value from the PTE and includes determining, by the MMU, to update one or more status bits within the PTE. The PTE is re-read. The re-reading obtains a second value from the PTE. The PTE is updated to include the one or more status bits, based on a match between the first and second value. The updated PTE is stored in a page table. The re-reading, the updating, and the storing are performed atomically.

### RELATED APPLICATIONS

This application claims the benefit of U.S. provisional patent applications “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, and “In-Order Multithreading With Pipeline Flush And Instruction Replay” Ser. No. 63/870,916, filed Aug. 27, 2025.

Each of the foregoing applications is hereby incorporated by reference in its entirety.

### FIELD OF ART

This application relates generally to instruction execution and more particularly to atomic updating of page table entry status bits.

### BACKGROUND

Efficient processors are paramount across all types of computer systems, from enterprise-level cloud computers to small, portable, and IoT devices, due to their ability to significantly enhance performance, reduce energy consumption, and improve overall system reliability. In enterprise and cloud computing environments, efficient processors ensure that large-scale data processing, storage, and retrieval tasks are handled swiftly and effectively, optimizing resource utilization and minimizing operational costs. For small, portable devices such as smartphones, tablets, and laptops, efficient processors extend battery life and enable more powerful applications without generating excessive heat. In the realm of IoT devices, which often operate on limited power and have stringent performance requirements, efficient processors enable seamless connectivity and data processing while maintaining low power consumption.

Main categories of processors include Complex Instruction Set Computer (CISC) types, and Reduced Instruction Set Computer (RISC) types. In a CISC processor, one instruction may execute several operations. The operations can include memory storage, loading from memory, an arithmetic operation, and so on. In contrast, in a RISC processor, the instruction sets tends to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors may be designed using a Hardware Description Language (HDL). Examples of such languages can include Verilog, VHDL, etc.

HDLs enable the description of behavioral, register transfer, gate, and switch level logic. This provides designers with the ability to define levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool, which in turn creates the gate-level abstraction of the design that is used for downstream implementation operations.

The efficiency of a processor is a critical factor influencing the performance, power consumption, and overall user experience of modern products. As technology continues to advance, there is a growing emphasis on developing processors that strike a balance between high performance and energy efficiency, so as to meet the diverse needs of various applications and industries. Thus, the advancement and deployment of efficient processors drive innovation and scalability, allowing diverse computing systems to operate at peak efficiency, deliver superior user experiences, and support the growing demands of modern technology ecosystems.

### SUMMARY

Disclosed techniques address the pitfalls that can occur in systems that use a translation lookaside buffer (TLB) by providing techniques for atomic updating of page table entry status bits. One or more exemplary implementations can include accessing a processor core that includes a memory management unit (MMU) and a load store unit (LSU). When a TLB miss occurs, the MMU of the processor performs a page table walk to identify a page table entry (PTE) for a virtual to physical address translation. In addition to address translation information, the PTE can include one or more status bits. In exemplary implementations, the MMU communicates the identified PTE to the LSU, and the identified PTE is read by the LSU to request a first value. In embodiments, the requesting includes the first value from the PTE.

Status bits that need to be updated are determined. The status bit can include an accessed (A) bit, and a dirty (D) bit, as well as other status bits. The LSU re-reads the PTE. The re-read can include performing a read-modify-write operation. The re-read results in a second value. The second value is compared to the first value, and in response to the first value and second value being equal, the PTE entry is updated and stored within the page table, where the re-reading, updating, and storing are performed atomically. Situations where the first value and second value are unequal can occur when multiple processes are accessing the page table, and at some point in time after obtaining the first value, but before obtaining the second value, another process changes the PTE data. In cases where the first value does not match the second value, a page fault may be generated. In some exemplary implementations, a third read is performed atomically to obtain a third value, and if the second value matches the third value, then the PTE entry is updated and stored within the page table, where the re-reading, updating, and storing are performed atomically. This technique serves to prevent unnecessary page faults, thereby improving overall processor performance.

Techniques for atomic updating of page table entry status bits are disclosed. A processor core includes a memory management unit (MMU) and a load store unit (LSU). The MMU of the processor performs a page table walk to identify a page table entry (PTE) for a virtual to physical address translation. In addition to address translation information, the PTE includes one or more status bits. The MMU communicates the identified PTE to the LSU, and the identified PTE is read by the LSU to request a first value. The LSU re-reads the PTE. The re-read results in a second value. The second value is compared to the first value, and in response to the first value and second value being equal, the PTE entry is updated and stored within the page table, where the re-reading, updating, and storing are performed atomically.

A processor-implemented method for instruction execution is disclosed comprising: accessing a processor core, wherein the processor core supports virtual memory addressing, and wherein the processor core includes a memory management unit (MMU) and a load store unit (LSU); performing, by the MMU, a page table walk, wherein the page table walk is responsive to a memory operation, wherein the page table walk identifies a page table entry (PTE) for a virtual to physical address translation; reading the PTE, wherein the reading obtains a first value from the PTE, and wherein the reading includes determining, by the MMU, to update one or more status bits within the PTE; re-reading, by the LSU, the PTE, wherein the re-reading obtains a second value from the PTE; updating, by the LSU, the PTE, wherein the updating includes the one or more status bits, wherein the updating is based on a match between the first value and the second value; and storing, in a page table, the PTE that was updated, wherein the re-reading, the updating, and the storing are performed atomically. In embodiments, the updating includes setting an accessed bit. In embodiments, the setting the accessed bit is based on it not already being set. In embodiments, the determining is based on a dirty bit. In embodiments, the dirty bit indicates whether a virtual page has been written since the dirty bit was last cleared. In embodiments, the memory operation is a store instruction. In embodiments, the updating includes setting the dirty bit. In embodiments, the setting the dirty bit is based on it not already being set.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for atomic updating of page table status bits.

FIG. 2 is a flow diagram for updating page table entry bits.

FIG. 3 is a block diagram of a multicore processor.

FIG. 4 is a block diagram of a pipeline.

FIG. 5 is a block diagram for a page table walk.

FIG. 6 is a block diagram for reading a page table entry.

FIG. 7 is a block diagram for updating a page table entry.

FIG. 8 is a system diagram for atomic updating of page table status bits.

### DETAILED DESCRIPTION

Low latency memory access is critically important in a processor system because it directly affects the speed and efficiency of data retrieval and processing, which in turn impacts overall system performance. Low latency for memory accesses ensures that the processor can quickly read and write data from memory, reducing the time spent waiting for data to be fetched or stored. This is particularly crucial in high-performance computing applications, such as gaming, real-time data analysis, and scientific simulations, where rapid data access is essential for maintaining smooth and responsive operations. In enterprise environments, low latency memory access is vital for managing large-scale databases, executing complex transactions, and supporting high-speed network communications. Efficient memory access contributes to lower response times and increased throughput, which are critical for maintaining service quality and user satisfaction. For small, portable devices and IoT systems, low latency memory access helps maintain responsiveness and energy efficiency, which are key factors for user experience and battery life. In these systems, efficient memory access allows for faster execution of tasks, smoother multitasking, and better overall performance without excessive power consumption.

Another factor that plays a role in the performance of computing systems is the cache hierarchy. An efficient cache hierarchy within a computer system can provide significant performance improvements. Caches are faster than main memory. An efficient cache hierarchy ensures that frequently accessed data is readily available in the fastest (closest to the processor) and smallest cache levels, reducing the time taken to access data and instructions. This enhances the overall system performance. By placing frequently used data closer to the processor, a good cache hierarchy helps in reducing memory access latency. This means that the processor spends less time waiting for data, which can otherwise cause significant delays in program execution. Moreover, caches can help reduce power consumption and improve energy efficiency by minimizing the need to access the larger, slower main memory. Accessing the cache often consumes less power than accessing the main memory, leading to overall energy savings in the system. Furthermore, by storing frequently accessed data closer to the processor, an effective cache hierarchy minimizes the amount of data that needs to be fetched from the slower main memory. This reduces the memory traffic and alleviates memory bus congestion, thus enhancing overall system efficiency.

The translation lookaside buffer (TLB) plays a crucial role in reducing memory latency in a processor system by improving the efficiency of virtual memory address translation. Exemplary implementations use virtual memory to provide each process with its own address space, enhancing security and simplifying memory management. However, this requires translating virtual addresses to physical addresses, a process that can be time consuming if handled solely by a page table stored in memory, disk, and so on. The TLB can be a specialized cache that stores recent translations of virtual addresses to physical addresses. When the processor needs to access a memory location, it first checks the TLB. If the translation is found (a TLB hit), the address translation can be completed quickly, bypassing the need to access the page table in main memory. By caching frequent address translations, the TLB reduces the number of page table accesses, thus speeding up memory access.

During context switches between processes, the TLB helps maintain fast address translations by storing the translations of the most recently used addresses. Although context switches may lead to some TLB entries being flushed or invalidated, the presence of the TLB still reduces the overhead compared to reloading the entire page table from scratch. Once the physical address is obtained quickly from the TLB, the processor can then use this address to fetch data from the cache hierarchy, memory, and so on. By reducing the time required for address translation, the TLB enhances the overall performance of the processor system. Faster address translation leads to quicker data access, higher instruction throughput, and improved efficiency of the processor.

While the translation lookaside buffer (TLB) is instrumental in speeding up virtual-to-physical address translation, encountering page faults when using a TLB can lead to several disadvantages. A page fault occurs when the memory access is not in the TLB or the page table and requires retrieving data from secondary storage (like a hard disk or SSD), which is considerably slower. Page faults can cause substantial delay because the required page must be loaded from secondary storage into main memory. This process can be orders of magnitude slower than accessing data in RAM or from the TLB, causing a noticeable slowdown in system performance. To make matters worse, multiple processes can be running on a processor, each one accessing their own virtual space. Further, multiple processors can exist within an SoC, each with multiple processes, or threads, accessing the same main memory system. In this case, TLB entries may be invalidated and/or evicted from the TLB frequently, leading to more page faults and reduced performance benefits from the TLB. When multiple threads, processes, etc. are present, the TLB must keep track of details associated with each page table entry (PTE) within the TLB such as when it was last accessed, whether it was changed, and so on. This management can be cumbersome and can lead to lower performance.

Techniques for atomic updating of page table entry status bits are disclosed. A memory operation for which the TLB does not contain the needed address information for the memory operation results in a “TLB miss.” A page table walk is performed as part of a memory operation when a TLB miss occurs. The page table walk can serve as a search for a page table entry (PTE) that contains the information to map a virtual address to a physical address in order to complete the memory operation. The memory operation can include a read operation, load operation, write operation, store operation, and so on. Status bits within the PTE serve to enforce coherent memory operations, ensuring predictable behavior in shared memory systems. The status bits can include an accessed (A) bit. The A bit can be asserted when a process reads or writes a virtual page corresponding to a fetched PTE. The A bit can indicate that the virtual page has been read, written, or fetched since the last time the A bit was cleared. The status bits can include a dirty (D) bit. The D bit can be asserted when the corresponding virtual page has been written since the last time the D bit was cleared. The status bits can include a readable (R) bit. The R bit can indicate if a page corresponding to a PTE is readable. The status bits can include a writable (W) bit. The W bit can indicate if a page corresponding to a PTE is writable. The status bits can include an executable (X) bit. The X bit can indicate if a page corresponding to a PTE is executable. In cases where the R bit, W bit, and X bit are all de-asserted (e.g., set to zero), it can be indicative of a PTE that is a pointer to a next-level PTE. If at least one of the R bit, W bit, or X bit are asserted (nonzero), it can be indicative of a last-level (leaf) PTE. The status bits can include a user mode (U) bit. The U bit can indicate if a page corresponding to a PTE is accessible to user mode processes. The status bits can include a valid (V) bit. The V bit can indicate if a page corresponding to a PTE is valid. When a PTE is accessed for reading or writing, one or more status bits may need to be changed in order to maintain memory coherency. Disclosed techniques enable efficient updating of PTE entries, including status bits, while maintaining memory coherency.

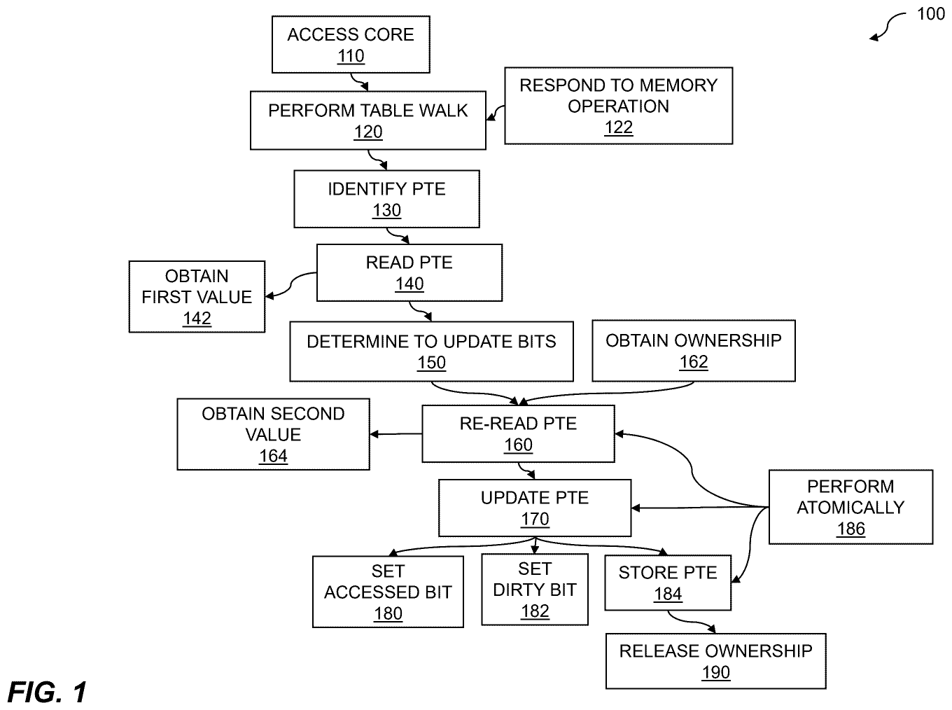

FIG. 1 is a flow diagram for atomic updating of page table status bits. The flow 100 includes accessing a processor core 110. The processor core can be included on a multi-processor chip, an application specific integrated circuit (ASIC), a system-on-a-chip (SOC), and so on. The processor core can execute instructions that are part of an instruction set architecture (ISA) such as X86, ARM, MIPS, RISC-V, and so on. The processor core supports virtual memory addressing. The processor core can be coupled to a memory hierarchy. The memory hierarchy can include L1, L2, L3, and/or other levels of caches. The memory hierarchy can include memory such as DRAM, SDRAM, and so on. The processor core can be configured to execute vector instructions, scalar instructions, micro-operations, and so on. The processor core includes a memory management unit (MMU). The MMU can enable the translation of virtual addresses to physical addresses. The MMU translates virtual addresses generated by the processor into physical addresses used by the memory hardware. This can allow programs to use virtual memory addresses that can be mapped to different physical locations. The MMU can utilize page tables to keep track of the mapping between virtual and physical addresses. In exemplary implementations, the MMU enforces memory protection by checking access permissions for each memory access. In exemplary implementations, the MMU supports paging, a memory management scheme that can eliminate the need for contiguous allocation of physical memory. By dividing memory into fixed-size pages, the MMU allows for more flexible and efficient use of memory. The size of the pages can be any appropriate size such as 1 KB, 2 KB, 4 KB, 1 MB, and so on. In exemplary embodiments, the MMU interfaces with the TLB. A TLB hit allows for rapid address translation without consulting the page table in memory. In exemplary implementations, the MMU supports virtual memory systems that use secondary storage (such as disk storage) to extend the apparent amount of available memory. Thus, the MMU can facilitate the swapping of pages between physical memory and secondary storage.

Moreover, in exemplary implementations, the MMU can enable page fault handling. When a required page is not in physical memory, the MMU can generate a page fault exception. The page fault can be handled by the processor, the operating system, and so on. The handling can load the necessary page from secondary storage into memory.

The processor core includes a load store unit (LSU). In exemplary implementations, the LSU enables handling of memory operations, including the loading (reading) and storing (writing) of data between the processor registers and the main memory or cache. In exemplary implementations, the LSU plays a vital role in ensuring efficient and correct execution of memory access instructions, which are integral to the functioning of the processor. In exemplary implementations, the LSU manages instructions that read data from memory and send data to processor registers. LSU operations can include fetching the required data from the cache or main memory and placing it into the appropriate register. Additionally, the LSU can process instructions that write data from processor registers to memory. In exemplary implementations, the LSU calculates the effective memory address for load and store operations based on the instruction base address, offsets, index values, and so on. This address calculation is crucial for accessing the correct memory location. In exemplary implementations, the LSU integrates with the processor's instruction pipeline, managing the execution of memory access instructions and ensuring they are carried out efficiently within the pipeline stages. In exemplary implementations, the LSU enables out-of-order execution, by managing the reordering of load and store instructions to maximize performance while preserving proper ordering of memory operations.

The flow 100 includes performing, by the MMU, a page table walk 120. The page table walk can be a process in virtual memory operations within a processor system where the memory management unit (MMU) translates a virtual address into a physical address using data obtained by traversing the page tables. A page table walk process can be invoked when a requested virtual address is not found in the translation lookaside buffer (TLB). The page table walk is responsive to a memory operation 122. The memory operation can include a load operation, store operation, copy operation, move operation, and so on.

The flow 100 includes identifying a page table entry 130. The page table walk identifies a page table entry (PTE) for a virtual to physical address translation. Page tables are data structures used to map virtual addresses to physical addresses. The page tables can be hierarchical, and may include multiple levels to efficiently manage large address spaces. The lowest level of PTEs may be referred to as leaf PTEs. The flow 100 includes reading a PTE 140. In embodiments, the PTE is a leaf PTE. The PTE can include a physical page number (PPN), one or more of the aforementioned status bits, other status bits, and so on. The reading obtains a first value 142 from the PTE. The first value can include a PPN, as well as the values of one or more of the aforementioned status bits, other status bits, and so on.

The flow 100 can include determining to update bits 150. The reading includes determining, by the MMU, to update one or more status bits within the PTE. The determining can be based on the reading. The determining can be based on a combination of memory instruction type and/or one or more control bits. For example, a read operation can require setting the A bit, while a write operation can require setting the A bit and the D bit. In embodiments, the determining is based on an accessed bit, wherein the accessed bit indicates whether a virtual page has been read, written, or fetched since the accessed bit was last cleared. For example, a load or store memory operation could have initiated the page table walk. In either case, accessing the PTE can occur. Thus, the access bit can be set if it was not previously set, regardless of the type of memory operation. In other embodiments, the determining is based on a dirty bit, wherein the dirty bit indicates whether a virtual page has been written since the dirty bit was last cleared. In this case, the PTE will be written if the memory operation that caused the page table walk was a store. Thus, in embodiments, the memory operation is a store instruction. As in the previous case, in embodiments, the updating includes setting an accessed bit, wherein the accessed bit is not set. In further embodiments, the updating includes setting the dirty bit, wherein the dirty bit is not set.

The flow 100 further includes re-reading, by the LSU, the PTE 160. The re-reading can include an atomic operation, such as a read-modify-write operation. An atomic operation in a processor system can be an operation that is performed as a single, indivisible unit. This means that once an atomic operation begins, it will run to completion without being interrupted, ensuring that no other operation can observe it in a partially completed state. In exemplary implementations, atomic operations can be used for ensuring data consistency and synchronization in multi-threaded and multi-core environments. A read-modify-write (RMW) operation is one type of atomic operation used in exemplary implementations. The flow 100 can include obtaining ownership 162. In embodiments, the re-reading includes obtaining ownership, by the LSU, of the PTE. The obtaining ownership can include a test-and-set instruction that tests a memory location (or register), sets a lock, and updates one or more bits within the memory location if not already set. In exemplary implementations, this operation is atomic and ensures that only one process can set the lock at a time. The flow 100 can include obtaining a second value 164. The re-reading obtains a second value from the PTE. In exemplary embodiments, the second value can be compared to the first value that was obtained. If the first value is equal to the second value, the PTE can be updated. If the first value is unequal to the second value, this can indicate that another process could have modified the PTE after the original read was performed. A page-fault and/or other mitigation strategy may be executed in order to preserve memory coherence.

The flow 100 further includes updating, by the LSU, the PTE 170. The updating includes the one or more status bits. The status bits can include the accessed (A) bit, the dirty (D) bit, and/or other status bits. The updating is based on a match between the first value and the second value. When the first value and the second value match, the status bits can be updated safely. As described above, a mismatch between the first value and the second value can indicate that another process could have modified the PTE after the first value was obtained.

The flow 100 can include setting the accessed bit 180. In exemplary implementations, the accessed bit is not set prior to the updating. This can indicate that a virtual page associated with the PTE has not been read, written, or fetched since the accessed bit was last cleared. In further embodiments, the updating includes setting an accessed bit, wherein the accessed bit is not set. If the accessed bit was not previously set, the bit can be set whether the access was due to a load or store instruction. The flow 100 can include setting the dirty bit 182. In embodiments, the memory operation is a store instruction. A store instruction can require an update to a PTE. In this case, if the dirty bit had not already been set, the bit can be set as a result of the updating due to the store instruction. In embodiments, the updating includes setting the dirty bit, wherein the dirty bit is not set. The dirty bit not being set can indicate that a virtual page associated with the PTE has not been written since the dirty bit was last cleared. The updating can include other bits within the PTE.

The flow 100 includes storing, in a page table, the PTE 184 that was updated. The storing can include storing a physical page number and/or one or more status bits. The flow 100 can include performing operations atomically 186. The re-reading, the updating, and the storing are performed atomically. Thus, an intervening read or write to the same PTE cannot interfere with the re-reading, updating, and storing process. Instead, an intervening read or write can stall until the atomic operation is complete. The flow 100 includes releasing ownership 190. In embodiments, the storing includes releasing ownership, by the LSU, of the PTE. In exemplary implementations, the releasing can include clearing a lock bit. In some exemplary implementations, the releasing can include retiring the instruction that modified the PTE. As mentioned previously, the control status registers can include a register for configuring page sizes, physical address extensions, process context identifier enabling, and so on. In embodiments, the determining, the updating, and the storing are based on one or more control status registers. The control status registers can include a control register with one or more bits for enabling paging, protection modes, various methods of handling PTE status bit updates, and so on. The control registers can be set by a user, by an operating system, and so on. The control status registers can include a register for configuring page sizes, physical address extensions, process context identifier enabling, and so on.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

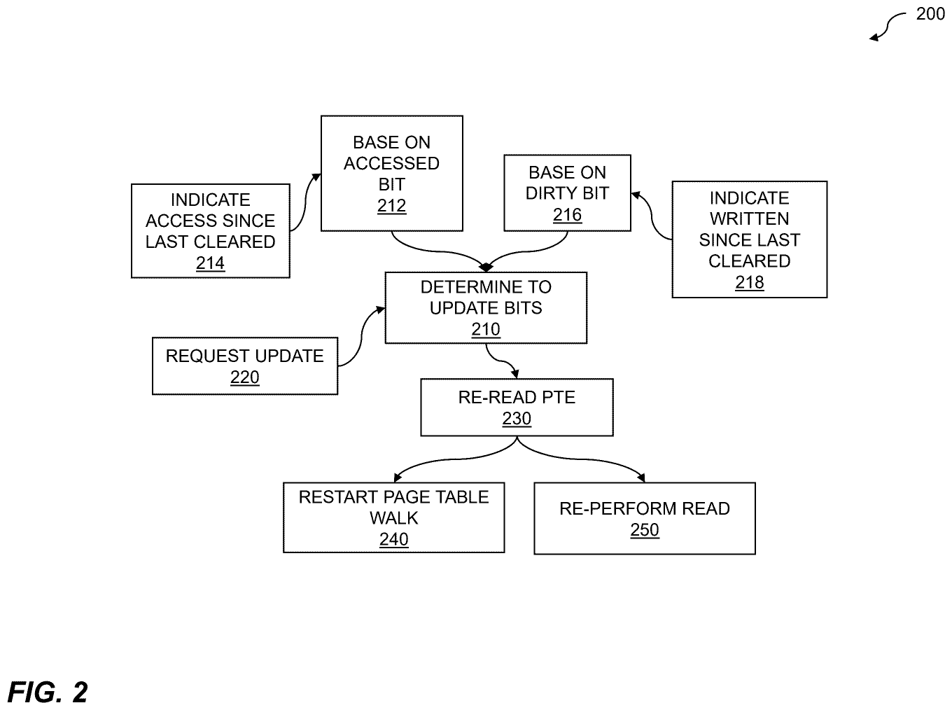

FIG. 2 is a flow diagram for updating page table entry bits. The flow 200 includes determining, by the LSU, to update one or more status bits 210 within the PTE. The determining can be based on the type of memory operation. For example, a read operation can require setting the A bit, while a write operation can require setting the A bit and the D bit. The updating can be based on one or more control status registers. The determining can be based on an accessed bit 212 which can indicate an access since the last time the accessed bit was cleared 214. In embodiments, the determining is based on an accessed bit, wherein the accessed bit indicates whether a virtual page has been read, written, or fetched since the accessed bit was last cleared. If the accessed bit is already set, then no action on the accessed bit needs to be taken. The determining can be based on a dirty bit 216 which can indicate whether a virtual page has been written since the dirty bit was last cleared 218. In further embodiments, the determining is based on a dirty bit, wherein the dirty bit indicates whether a virtual page has been written since the dirty bit was last cleared. The accessed bit and dirty bit can be used to manage memory paging (or memory swapping).

The flow 200 can include requesting an update 220. The MMU and LSU can operate in conjunction to perform memory operations such as loads and stores in a virtual memory environment that utilizes a TLB and one or more page tables. In exemplary implementations, when the processor issues a load or store instruction, the LSU receives the instruction which can include the virtual address of the memory location to be accessed. The LSU can send the virtual address to the MMU to determine next actions to take in order to perform the intended memory operation. The MMU can provide information to the LSU regarding one or more PTE entries, bits within a PTE that need to be set, and so on. As explained above and throughout, a PTE can be read, which can result in a first value. The LSU can update one or more status bits within the PTE. Embodiments include requesting, by the MMU, the LSU to perform the updating. The request can include one or more addresses, control bits, and so on. In embodiments, the requesting includes an address of the PTE. In other embodiments, the requesting includes the first value from the PTE.

The flow 200 includes re-reading the PTE 230. In exemplary implementations, the re-reading is performed using an atomic operation, such as a read-modify-write operation.

The re-reading obtains a second value from the PTE. The re-reading can be necessary to determine whether another process, processor core, etc. had accessed or updated the PTE prior to updating status bits. Recall that the reading can produce a first value of the PTE, while the re-reading can produce a second value of the PTE. In embodiments, the first value and the second value do not match. The mismatch of the first value and second value can be indicative of another process changing a page table entry after the first read occurs, but before the second read occurs (which can begin an atomic sequence to update the PTE).

If the first and second PTE values do not match, then actions can be taken to ensure that data is not lost, corrupted, and so on. The flow 200 can include restarting the page table walk 240. In response to the mismatch, a page-fault can be issued. The page fault can restart the page table walk. Thus, embodiments include restarting the page table walk. However, a page-fault can have an adverse impact on processor performance. Other embodiments include re-performing 250 the reading, the re-reading, the updating, and the storing. Instead of restarting the page table walk, the second value can be compared to a third PTE value generated by the re-performing. A comparison can then be made between the second and third values. If the third value matches the second value, then the PTE bits can be updated accordingly. The process can be repeated until two consecutive reads produce a match. The re-performing can provide a performance enhancement as compared with restarting the page table walk. Additional actions can be taken to ensure that data is not lost when the first value does not match the second value.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

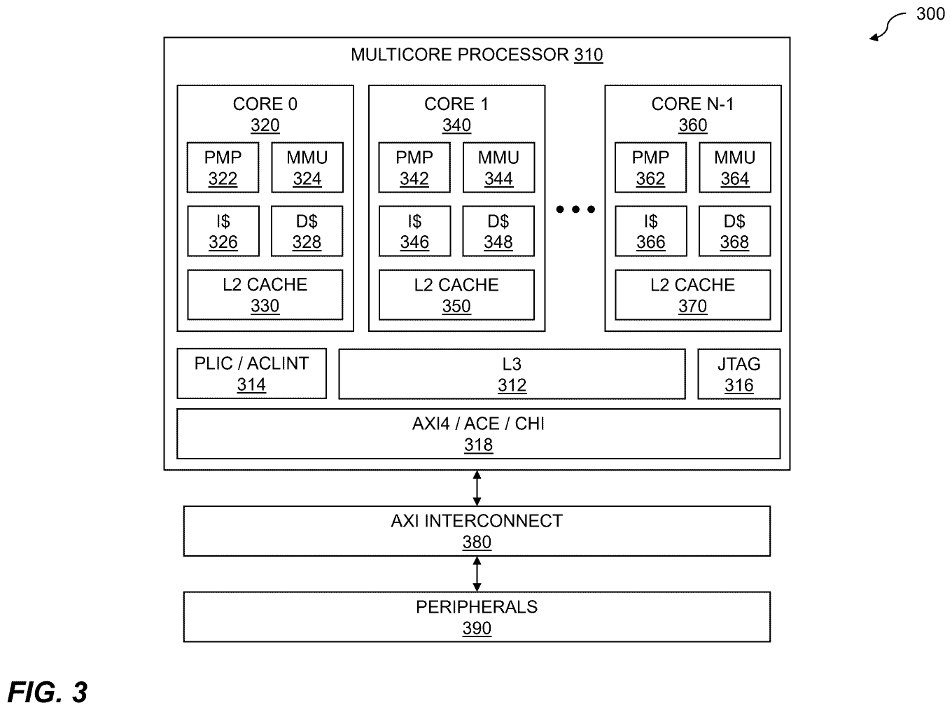

FIG. 3 is a block diagram of a multicore processor. The processor, such as a RISC-V™ processor, ARM processor, or other suitable processor type, can include a variety of elements. The elements can include processor cores including multiprocessor cores, one or more caches, memory protection and management units, local storage, and so on. The elements of the multicore processor can further include one or more of a private cache; a test interface such as a joint test action group (JTAG) test interface; one or more interfaces to a network such as a network-on-chip, shared memory, and peripherals; and the like. The processor cores can support virtual memory addressing. The processor cores can include a memory management unit (MMU) and a load store unit (LSU).

In the block diagram 300, the multicore processor 310 can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In one or more implementations, each core, including cores 0 through core N-1, can include a physical memory protection (PMP) element, such as PMP 322 for core 0; PMP 342 for core 1, and PMP 362 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses with caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N-1. In addition to the level 1 instruction and data caches, each core can include a level 2 (L2) cache. The level 2 caches can include L2 cache 330 associated with core 0; L2 cache 350 associated with core 1; and L2 cache 370 associated with core N-1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interruptor (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In one or more implementations, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

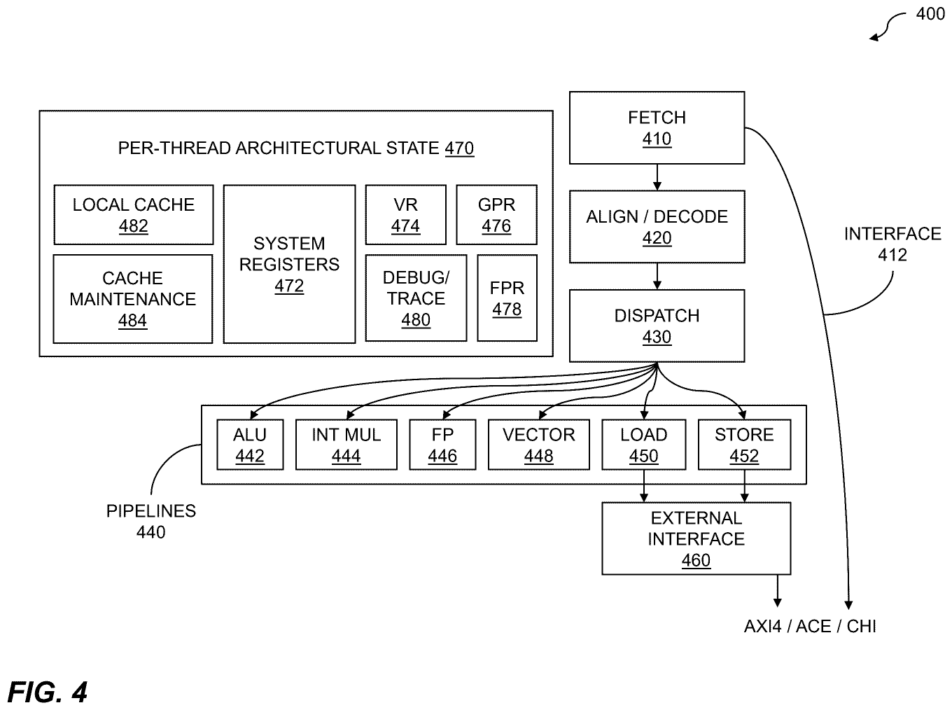

FIG. 4 is a block diagram of a pipeline. The use of one or more pipelines associated with a processor architecture can greatly enhance processing throughput. The processor architecture can be associated with one or more processor cores. The processing throughput can be increased because multiple operations can be executed in parallel. In one or more implementations, a processor core is accessed, where the processor core supports virtual memory addressing. The processor core can include a memory management unit (MMU) and a load store unit (LSU). The MMU can perform a page table walk. The page table walk is responsive to a memory operation. The page table walk identifies a page table entry (PTE) for a virtual to physical address translation. The PTE is read, and a determination is made by the LSU to update one or more status bits within the PTE. The status bits can include an accessed bit, dirty bit, valid bit, and/or other bits within the PTE.

The blocks within the block diagram can be configurable in order to provide varying processing levels. The varying processing levels can be based on processing speed, bit lengths, numbers of micro-operations, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 470. The inclusion of the per-thread architectural state can be based on a configuration or architecture that can support multi-threading. In one or more exemplary implementations, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474. The vector registers can be grouped in a vector register file and can be used for vector operations. Additional registers, such as general-purpose registers (GPR) 476 and floating-point registers (FPR) 478, can be included. These registers can be used for general purpose (e.g., integer) operations, and floating-point operations, respectively. The per-thread architectural state can include a debug and trace block 480. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

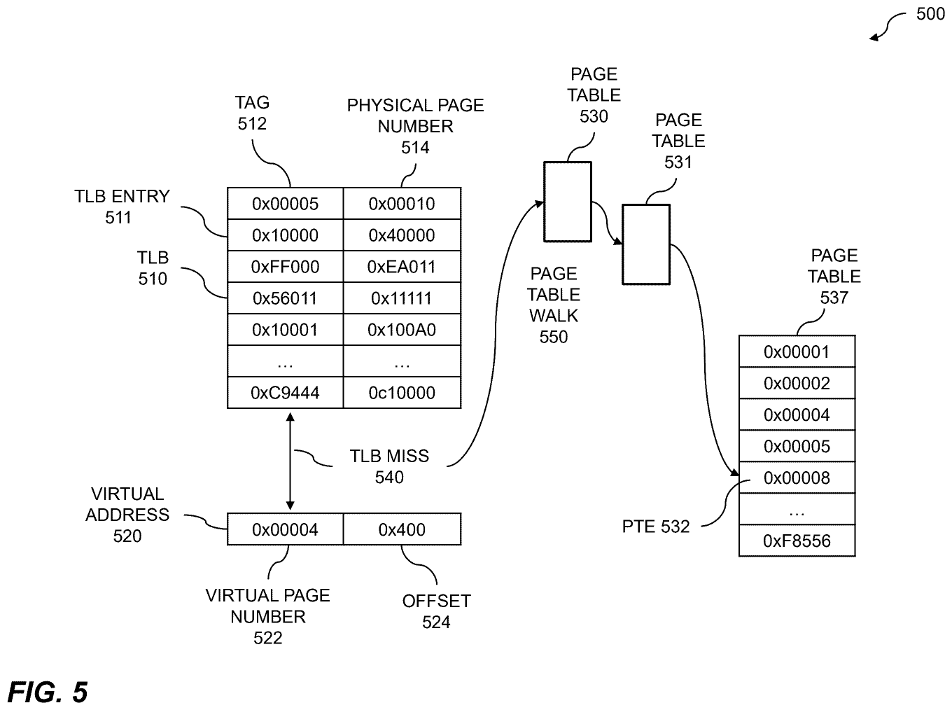

FIG. 5 is a block diagram for a page table walk. The block diagram 500 includes TLB 510. The TLB 510 can include multiple entries. The TLB includes a tag column 512, and a physical page number column 514. As an example, TLB entry 511 has a tag value of 0x10000 and a physical page number value of 0x40000. The block diagram 500 includes a virtual address 520. The virtual address can include a virtual page number 522, and an offset 524. In the example depicted in FIG. 5, the virtual address has a virtual page number that has a value of 0x0004, and an offset that has a value of 0x400. To process the memory request associated with virtual address, the tag column in the TLB is searched in an attempt to find an entry with a tag value that matches the virtual page number. In response to not finding a match, a page table walk 550 is initiated. The page table walk can include traversing through multiple page tables until a leaf PTE is reached. As illustrated in FIG. 5, the page table walk starts at a page table 530, and a corresponding PTE in page table 530 references a PTE in page table 531, which in turn references a corresponding PTE in page table 537, which is a leaf PTE. A leaf page PTE contains page table entries rather than pointers to other page tables. In embodiments, the PTE is a leaf PTE. The leaf PTE provides a physical page offset in the PTE indicated at 532. In exemplary implementations, page table 530 and page table 531 may be of a similar structure to page table 537. In one or more exemplary implementations, if the virtual page number 522 is not found in the TLB 510, it results in TLB miss 540, and as a result of the TLB miss, the MMU performs a page table walk to translate the virtual address to a physical address. During a page table walk, the MMU traverses one or more page tables to find the corresponding physical address. This process may involve multiple memory accesses to fetch page table entries until a leaf PTE is reached. The page table walk culminates in identifying page table 537. Within that page table, entry 4 is accessed (since the virtual page number is 0x00004). This corresponds to PTE 532. As a result, 0x00008 is sent back to the TLB. When combined with the offset, the resting physical address is 0x00008400. In one or more exemplary implementations, once the physical address is determined, the MMU updates the TLB with this new translation for faster access in the future and then returns the physical address to the LSU.

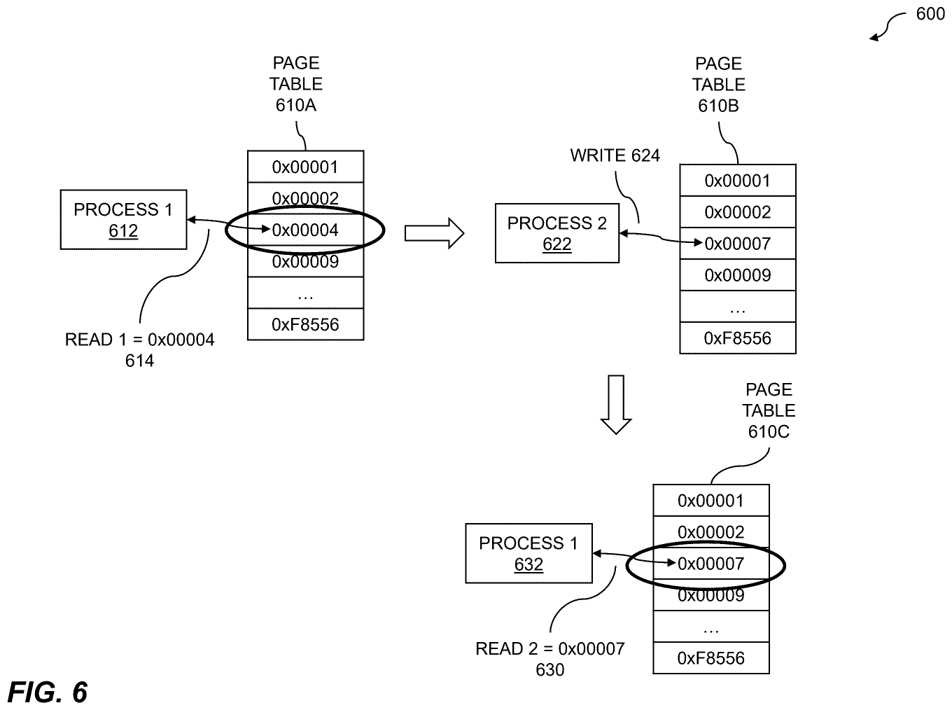

FIG. 6 is a block diagram for reading a page table entry. The block diagram 600 illustrates a scenario in which a first value obtained by a first read mismatches with a second value obtained by a second read. Page table 610A shows the contents of a page table at a first point in time, where a first process, process 1 (612), performs a first read 614 of a PTE within page table 610A, and obtains a first value of 0x0004. Page table 610B shows the contents of the same page table referred to at 610A, at a later point in time, after a second process, process 2 (622), performs a write 624, and changes the PTE that previously held the value 0x00004 to a new value of 0x0007. Page table 610C shows the contents of the same page table referred to at 610B, at a later point in time, where the first process, process 1 (shown here as block 632), performs a second read 630, and obtains the second value of 0x0007, which is a mismatch as compared with the first value of 0x0004. Accordingly, process 1 can take an action to maintain memory coherency. Embodiments include restarting the page table walk. Recall that the reading obtains a first value form the PTE (0x00004 in the case of block diagram 600). Recall also that the re-reading obtains a second value from the PTE (0x00007 in the case of block diagram 600). Finally, updating the PTE can occur when the first value and the second value are the same. Other embodiments include re-performing the reading, the re-reading, the updating, and the storing. Process 1 can re-perform the read, essentially reading the PTE a third time to obtain a third value, can compare the second value to the third value, and if the second value and third value match, can then the PTE can be updated without the need for a page fault, thereby improving processor performance. In particular, during heavy workloads or memory pressure, disclosed techniques can reduce the need for page faults; keeping the page fault rate low is a key factor in maintaining an acceptable level of system performance.

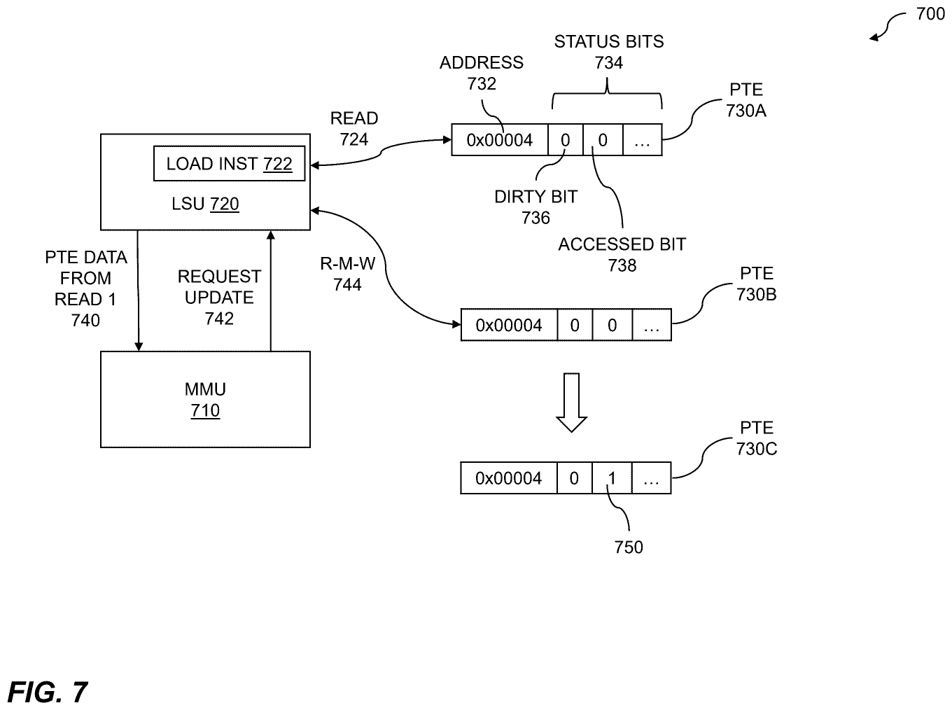

FIG. 7 is a block diagram for updating a page table entry. The block diagram 700 includes an MMU 710. In exemplary implementations, the MMU translates virtual addresses generated by running programs into corresponding physical addresses in the computer's memory. This translation ensures that the processor can access the correct locations in memory and interact with necessary data for execution of program instructions. Moreover, the MMU can provide memory protection, by designating access rights to various memory areas, enhancing memory security. Additionally, by managing virtual memory, the MMU allows efficient utilization of RAM. The MMU can enable processes to use more memory than is physically available by swapping data between RAM and disk storage. In exemplary implementations, the MMU divides memory into segments, each with specific attributes (e.g., code, data, stack, etc.) This segmentation aids in organizing and protecting memory regions.

The block diagram 700 includes a load store unit (LSU) 720. In exemplary implementations, the LSU handles various types of load and store instructions, ensuring proper coordination between memory accesses. The LSU can generate and/or obtain virtual addresses for load and store operations, allowing data to be loaded from memory or stored back to memory from registers. The MMU and the LSU are communicatively coupled to each other. At the start of a memory operation, such as a load or store, the MMU may check the TLB (e.g., 510 of FIG. 5) to determine if a corresponding physical page number entry exists in the TLB. If an entry exists, then the physical page number is retrieved from the TLB. In the event that no entry exists (TLB miss), the MMU can orchestrate a page table walk, such as illustrated in FIG. 5. In exemplary implementations, the MMU may coordinate with the LSU to perform the page table walk. In such coordination, the MMU may issue requests to the LSU, and the LSU may, in response, perform memory operations such as reading and writing of memory locations, including page tables. In embodiments, the memory operation is a store instruction.

The LSU may execute a load instruction 722. In general, the LSU memory instruction can be a write (store) instruction, or a read (load) instruction. To carry out the load instruction, the LSU can perform a read 724 of page table entry (PTE) 730A. PTE 730A includes an address 732, and one or more status bits 734, which include dirty bit 736 and accessed bit 738. As indicated at 740, the LSU provides the PTE data from PTE 730A to the MMU. The MMU can provide a request to update the PTE, as indicated at 742, to the LSU. In response to the request, the LSU can perform a second read, which can be an atomic read-modify-write operation 744. The read-modify-write operation operates on PTE 730B, which refers to the same page table entry as PTE 730A, at a subsequent point in time. The LSU, during the atomic read-modify-write operation, updates the accessed bit, as indicated at 750 in PTE 730C, which refers to the same page table entry as PTE 730B, at a subsequent point in time. Accordingly, the accessed bit is safely updated from a 0 to a 1, indicating that a read of that PTE has occurred.

In embodiments, the memory operation is speculative. Thus, in exemplary implementations, memory operations, such as loads and/or stores, can be performed speculatively. Thus, in embodiments, the updating is performed speculatively. Speculative execution can provide improved instruction throughput by predicting taken paths of branch instructions and executing instructions before the actual direction of a branch is known, which can include load and store instructions. Speculative execution can help to keep the pipeline full and minimize idle times. The execution of a speculative store instruction can include performing a page table walk, and multiple reads of a PTE as described herein. Recall that the MMU can determine to update one or more status bits within the PTE. In embodiments, the determining is based on an accessed bit, wherein the accessed bit indicates whether a virtual page has been read, written, or fetched since the accessed bit was last cleared. This can be true when the memory operation is speculative.

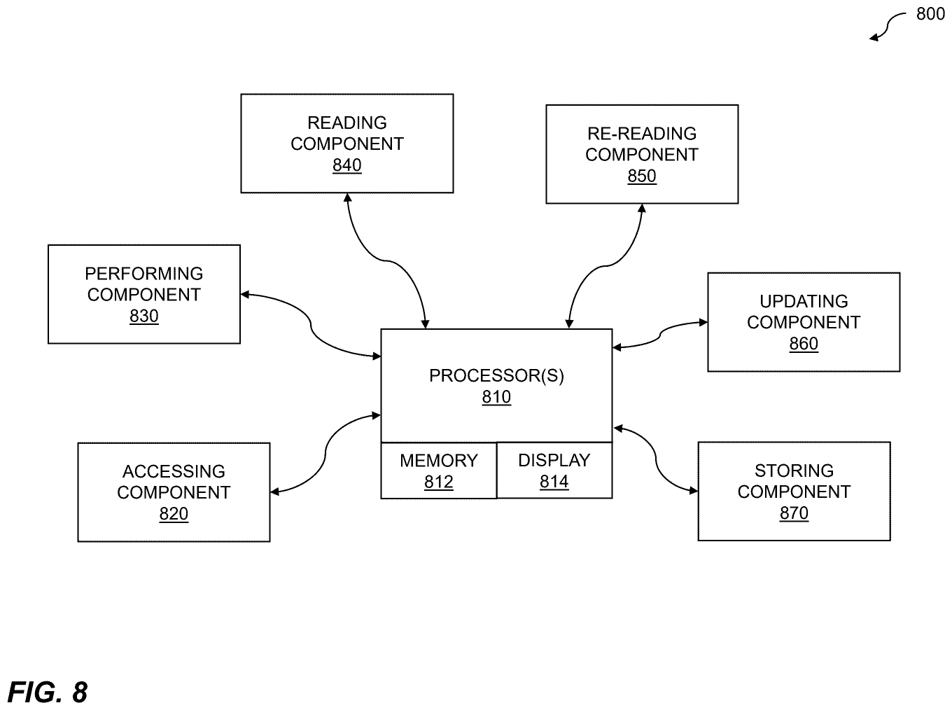

FIG. 8 is a system diagram for atomic updating of page table status bits. The system can comprise a computer system for communication. The computer system can be based on semiconductor logic. The system can include one or more of processors, memories, cache memories, queues, displays, communications channels and networks, and so on. The system 800 can include one or more processors 810. The processors can include standalone processors within integrated circuits or chips, processor cores in FPGAs or ASICs, two or more processor cores within a multiprocessor, and the like. The one or more processors are coupled to a memory 812, which stores instructions, operations, network traffic data, data requests, estimated latencies, accumulated latencies, routing information, and so on. The memory can include one or more of local memory, shared cache memory, shared hierarchical cache memory, system memory such as shared system memory, etc. The system 800 can further include a display 814 coupled to the one or more processors. The display can be used for displaying data, instructions, operations, memory queue contents, various types of latencies, PTEs, etc. The operations can route operations, data transfer operations, and so on. The operations can further include cache maintenance operations, Advanced eXtensible Interface (AXI™) Coherence Extensions (ACE™) cache transactions, Advanced Microcontroller Bus Architecture (AMBA™) Coherence Hub Interface (CHI™) transactions, etc.

The system 800 can include a computer system for instruction execution comprising: a memory which stores instructions; one or more processors coupled to the memory, wherein the one or more processors, when executing the instructions which are stored, are configured to: access a processor core, wherein the processor core supports virtual memory addressing, and wherein the processor core includes a memory management unit (MMU) and a load store unit (LSU); perform, by the MMU, a page table walk, wherein the page table walk is responsive to a memory operation, wherein the page table walk identifies a page table entry (PTE) for a virtual to physical address translation; read the PTE, wherein the reading obtains a first value from the PTE, and wherein the reading includes determining, by the MMU, to update one or more status bits within the PTE; re-read, by the LSU, the PTE, wherein the re-reading obtains a second value from the PTE; update, by the LSU, the PTE, wherein the updating includes the one or more status bits, wherein the updating is based on a match between the first value and the second value; and store, in a page table, the PTE that was updated, wherein the re-reading, the updating, and the storing are performed atomically.

The system 800 can include an accessing component 820. The accessing component can include functions and instructions for accessing a processor core. The processor core can include an ARM core, a MIPS core, and/or other suitable core type. In exemplary implementations, the processor core can include a RISC-V architecture. The processor core supports virtual memory addressing. The processor core includes a memory management unit (MMU) and a load store unit (LSU), along with a translation lookaside buffer (TLB), for support of the virtual memory addressing.

The system 800 can include a performing component 830. The performing component can include functions and instructions for performing, by the MMU, a page table walk. The page table walk can be responsive to a memory operation, where the page table walk identifies a page table entry (PTE) within a page table for a virtual to physical address translation. In exemplary implementations, the MMU manages the page tables and handles the translation between virtual and physical memory addresses. The system 800 can include a reading component 840. The reading component 840 can include functions and instructions for reading the PTE. The reading can result in obtaining a first value from the PTE. The reading can include determining, by the LSU, to update one or more status bits within the PTE. The status bits can include an accessed bit, dirty bit, and/or other associated status bits.

The system 800 can include a re-reading component 850. The re-reading component can include functions and instructions for re-reading, by the LSU, the PTE. The re-reading can include obtaining a second value from the PTE. The re-reading and subsequent functions can be performed atomically. The re-reading can be performed as part of a read-modify-write operation. The system 800 can include an updating component 860. The updating component can include functions and instructions for updating, by the LSU, the PTE. The updating can include the one or more status bits. The updating can be based on a match between the first value and the second value. The updating can include updating an accessed bit as part of executing a load operation. The updating can include updating both an accessed bit and a dirty bit as part of executing a store operation. The system 800 can include a storing component 870. The storing component 870 can include functions and instructions for storing, in a page table, the PTE that was updated. In exemplary implementations, the re-reading, updating, and the storing are performed atomically.

The system 800 can include a computer program product embodied in a non-transitory computer readable medium for instruction execution, the computer program product comprising code which causes one or more processors to generate semiconductor logic for: accessing a processor core, wherein the processor core supports virtual memory addressing, and wherein the processor core includes a memory management unit (MMU) and a load store unit (LSU); performing, by the MMU, a page table walk, wherein the page table walk is responsive to a memory operation, wherein the page table walk identifies a page table entry (PTE) for a virtual to physical address translation; reading the PTE, wherein the reading obtains a first value from the PTE, and wherein the reading includes determining, by the MMU, to update one or more status bits within the PTE; re-reading, by the LSU, the PTE, wherein the re-reading obtains a second value from the PTE; updating, by the LSU, the PTE, wherein the updating includes the one or more status bits, wherein the updating is based on a match between the first value and the second value; and storing, in a page table, the PTE that was updated, wherein the re-reading, the updating, and the storing are performed atomically.

As can now be appreciated, techniques are disclosed for atomic updating of page table entry status bits in a processor that supports virtual memory operations by use of a MMU, LSU, and TLB. By strategically performing multiple read operations of page table entries, and comparing the results, the number of page faults can be reduced, thereby improving overall processor performance. Thus, disclosed techniques enable efficient and secure memory access, while reducing the number of page faults, and providing the robust functionality of virtual memory systems.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or processor-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core supports virtual memory addressing, and wherein the processor core includes a memory management unit (MMU) and a load store unit (LSU);
performing, by the MMU, a page table walk, wherein the page table walk is responsive to a memory operation, wherein the page table walk identifies a page table entry (PTE) for a virtual to physical address translation;
reading the PTE, wherein the reading obtains a first value from the PTE, and wherein the reading includes determining, by the MMU, to update one or more status bits within the PTE;
re-reading, by the LSU, the PTE, wherein the re-reading obtains a second value from the PTE;
updating, by the LSU, the PTE, wherein the updating includes the one or more status bits, wherein the updating is based on a match between the first value and the second value; and
storing, in a page table, the PTE that was updated, wherein the re-reading, the updating, and the storing are performed atomically.

2. The method of claim 1 further comprising requesting, by the MMU, the LSU to perform the updating.

3. The method of claim 2 wherein the requesting includes an address of the PTE.

4. The method of claim 2 wherein the requesting includes the first value from the PTE.

5. The method of claim 1 wherein the re-reading includes obtaining ownership, by the LSU, of the PTE.

6. The method of claim 5 wherein the storing includes releasing ownership, by the LSU, of the PTE.

7. The method of claim 1 wherein the determining is based on an accessed bit, wherein the accessed bit indicates whether a virtual page has been read, written, or fetched since the accessed bit was last cleared.

8. The method of claim 1 wherein the determining is based on a dirty bit.

9. The method of claim 8 wherein the dirty bit indicates whether a virtual page has been written since the dirty bit was last cleared.

10. The method of claim 8 wherein the updating includes setting an accessed bit.

11. The method of claim 10 wherein the setting the accessed bit is based on it not already being set.

12. The method of claim 10 wherein the memory operation is a store instruction.

13. The method of claim 8 wherein the updating includes setting the dirty bit.

14. The method of claim 13 wherein the setting the dirty bit is based on it not already being set.

15. The method of claim 1 wherein the first value and the second value do not match.

16. The method of claim 15 further comprising re-performing the reading, the re-reading, the updating, and the storing.

17. The method of claim 15 further comprising restarting the page table walk.

18. The method of claim 1 wherein the memory operation is speculative.

19. The method of claim 18 wherein the updating is performed speculatively.

20. The method of claim 1 wherein the PTE is a leaf PTE.

21. The method of claim 1 wherein the determining, the updating and the storing are based on one or more control status registers.

22. A computer program product embodied in a non-transitory computer readable medium for instruction execution, the computer program product comprising code which causes one or more processors to generate semiconductor logic for:
accessing a processor core, wherein the processor core supports virtual memory addressing, and wherein the processor core includes a memory management unit (MMU) and a load store unit (LSU);
performing, by the MMU, a page table walk, wherein the page table walk is responsive to a memory operation, wherein the page table walk identifies a page table entry (PTE) for a virtual to physical address translation;
reading the PTE, wherein the reading obtains a first value from the PTE, and wherein the reading includes determining, by the MMU, to update one or more status bits within the PTE;
re-reading, by the LSU, the PTE, wherein the re-reading obtains a second value from the PTE;
updating, by the LSU, the PTE, wherein the updating includes the one or more status bits, wherein the updating is based on a match between the first value and the second value; and
storing, in a page table, the PTE that was updated, wherein the re-reading, the updating, and the storing are performed atomically.

23. A computer system for instruction execution comprising:
a memory which stores instructions;
one or more processors coupled to the memory, wherein the one or more processors, when executing the instructions which are stored, are configured to:
access a processor core, wherein the processor core supports virtual memory addressing, and wherein the processor core includes a memory management unit (MMU) and a load store unit (LSU);
perform, by the MMU, a page table walk, wherein the page table walk is responsive to a memory operation, wherein the page table walk identifies a page table entry (PTE) for a virtual to physical address translation;
read the PTE, wherein the reading obtains a first value from the PTE, and wherein the reading includes determining, by the MMU, to update one or more status bits within the PTE;
re-read, by the LSU, the PTE, wherein the re-reading obtains a second value from the PTE;
update, by the LSU, the PTE, wherein the updating includes the one or more status bits, wherein the updating is based on a match between the first value and the second value; and
store, in a page table, the PTE that was updated, wherein the re-reading, the updating, and the storing are performed atomically.
